(19) United States
(12) Patent Application Publication
(10) Pub. No.: US 2023/0034407 A1
(43) Pub. Date: Feb. 2, 2023

(54) TABLE SYSTEM WITH MAGNETIC RAILS AND ACCESSORIES

(71) Applicant: Wyrmwood, Inc., Taunton, MA (US)

(72) Inventors: Jason Eric MacDonald, Onset, MA (US); Douglas Joseph Costello, Lakeville, MA (US)

(73) Assignee: Wyrmwood, Inc., Taunton, MA (US)

(21) Appl. No.: 17/648,039

(22) Filed: Jan. 14, 2022

Related U.S. Application Data
(60) Provisional application No. 63/227,044, filed on Jul. 29, 2021.

(51) Int. Cl. A47B 13/16; A47B 13/08; A47B 25/00; F16B 5/00

(52) U.S. Cl. CPC A47B 13/16; A47B 13/081; A47B 25/00; F16B 5/0012

(57) ABSTRACT

A furniture system includes a piece of furniture with a groove. A magnetically attractive element is placed about the groove. A furniture accessory has a tongue that can fit into the groove. Magnets positioned about the tongue engage with the magnetically attractive element to hold the accessory in place. The magnetic force is sufficient to secure the accessory in its location within the groove while allowing for repositioning or removal of the accessory with relative ease.

### RELATED APPLICATIONS

This application claims priority to and benefit of U.S. Provisional Patent Application No. 63/277,044 (filed Jul. 29, 2021) which is incorporated here by reference in its entirety.

### FIELD

This patent relates to specialized furniture and, more particularly, to gaming tables with magnetic rails and accessories.

### BACKGROUND

Gaming furniture has become popular with board game enthusiasts who desire a space dedicated to playing games with family and friends. However, furniture dedicated only to a hobby can result in an inefficient use of living space. Furniture that serves dual purposes for dining and entertaining, as well as hosting games, would be beneficial and convenient. Additionally, it would be beneficial to provide furniture that can be quickly and easily configured with the addition or removal of customized accessories.

### SUMMARY

A furniture system that provides options for reconfiguration, addition and removal of accessories, and secure retention of the accessories comprises: a piece of furniture having a magnetically attractive rail along at least one side of the piece of furniture, the rail positioned within a groove on the side of the piece of furniture; and a furniture accessory configured to attach to the piece of furniture, the furniture accessory having a tongue; and magnetic elements disposed about the tongue, the magnetic elements configured to interact with the rail to hold the furniture accessory in place when the tongue is inserted into the groove.

In another embodiment, A piece of furniture comprises a groove along at least one side of the piece of furniture; and a magnetically attractive rail positioned within the groove. The groove is configured to accept a furniture accessory having a tongue and having magnetic elements disposed about the tongue, the magnetic elements configured to interact with the rail to hold the accessory in place when the tongue is inserted into the groove.

In another embodiment, a furniture accessory includes a tongue configured to be inserted into a groove of a piece of furniture; and magnetic element disposed about the tongue, the magnetic elements configured to interact with a magnetically attractive element of a piece of furniture to hold the furniture accessory in place when the tongue is inserted into a first groove of the piece of furniture.

### BRIEF DESCRIPTION OF THE DRAWINGS

The foregoing features may be more fully understood from the following description of the drawings. The drawings aid in explaining and understanding the disclosed technology. Since it is often impractical or impossible to illustrate and describe every possible embodiment, the provided figures depict one or more exemplary embodiments. Accordingly, the figures are not intended to limit the scope of the invention. Like numbers in the figures denote like elements.

FIG. 1 is a diagram of a table with a magnetic rail and a game deck accessory with a magnetic rail.

FIG. 2 is a diagram of a table with a magnetic rail and a game deck accessory with a magnetic rail, where the game deck is positioned on the table.

FIG. 3 is a diagram of a table with a magnetic rail and a game deck accessory with a magnetic rail, where the game deck is positioned on the table and magnetic accessories are positioned along the accessory rail of the game deck.

FIG. 4A is an exploded view of a table apron and table top piece.

FIG. 4B is a cross sectional view of a table apron and a table top piece.

FIG. 5 is a side view of a desk accessory with a second accessory installed in a groove of the desk accessory.

FIG. 6 is an exploded view of a cup holder accessory including magnets.

FIG. 7 is an exploded view of a desk furniture accessory.

FIG. 8 is a side view of a table apron, desk accessory, and second accessory.

FIG. 9 is a top view of a table with player desk and game deck accessories installed. A cup holder accessory is positioned in the magnetic rail of the player desk and another cup holder accessory is positioned in the magnetic rail of the player desk.

### DETAILED DESCRIPTION

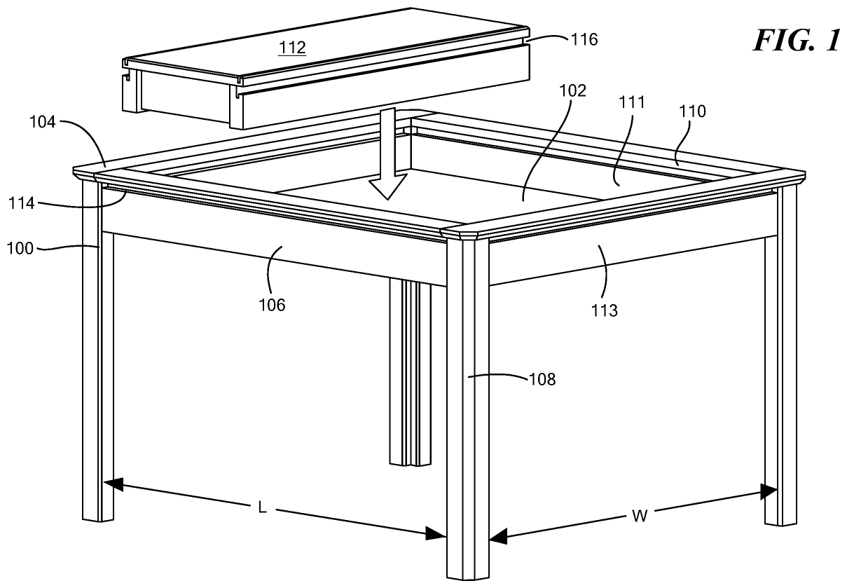

FIG. 1 is a diagram of a piece of furniture, in this example a table 100, that includes grooves that can accept furniture accessories. The table 100 in FIG. 1 is a table designed for playing board games, however any table or piece of furniture can be used in conjunction with this disclosure.

The table 100 includes a recessed playing surface 102 that may be at a lower height than the top surface 104 of the table 100. The surface 102 may be covered with felt or another material. The table may also include a tabletop piece (not shown) that can be placed on top of surface 104. The tabletop piece can cover games or other activities or material that are placed on playing surface 102. The tabletop can also provide a place for users to eat, write, or perform other traditional table activities.

Table 100 may include a plurality of “aprons” 106, that extend vertically downward from the top piece 104 of the table 100 and form the sides of the table. In the example shown in FIG. 1, table 100 has four aprons—one on each of four sides. In other embodiments table 100 may have three sides (some or all of which include an apron) or more than four sides (some or all of which an apron).

Table 100 may be a modular table. For example, table 100 may include removable or replaceable table legs 108 positioned between the sides. In embodiments, the aprons 106 may be joined to the legs 108 and the surface 102 in a way that is easy to assemble and disassemble. This may allow any of the aprons to be replaced with aprons of a different length, any of the legs to be replaced with legs of a different height, and/or the surface 102 to be replaced with a surface 102 of a different size. This may allow for customization during ordering and manufacturing, and may also allow the end user to customize or change the configuration of the table 100 after purchase.

Some or all the aprons 106 may include an inner lip or rail 110 that can support a deck accessory 112, the tabletop piece mentioned above, or another accessory that is fitted to sit atop the rails 110. The rails 110 may extrude from the apron 106 to create a surface edge on which the deck accessory 112 can sit. In embodiments, the desk accessory 112 can slide back and forth along the length L of the table. In other embodiments, depending on the position of the rails 110, the accessory 112 may be able to slide along the width W of the table.

One or more of the aprons 106 may also include a magnetically attractive element 114 formed from a magnetically attractive material, like a metal such as iron, an iron composite, cobalt, other magnetic alloys and earth metals, or the like. The element may take the form of a metal bar, a metal rod, a metal foil, a metal strip, etc. The Alternatively, the magnetic element 114 may be formed from a permanent magnet material such like ferrite, alnico alloy, etc. In yet other embodiments, the magnetic element 114 may comprise an electromagnet that is powered by an electrical power source. In this case, the electromagnet may be turned on or off to provide a magnetic field.

The aprons 106 may include magnetic elements 114 on an inner surface 111 of the table, on an outer surface 113 of the table, or both. As will be described below, the magnetic elements 114 may be placed within or near a groove that can accept a furniture accessory.

The game deck accessory 112 may also include magnetic elements 116 one or more sides, which may be the same as or similar to magnetic elements 114 of the table 100.

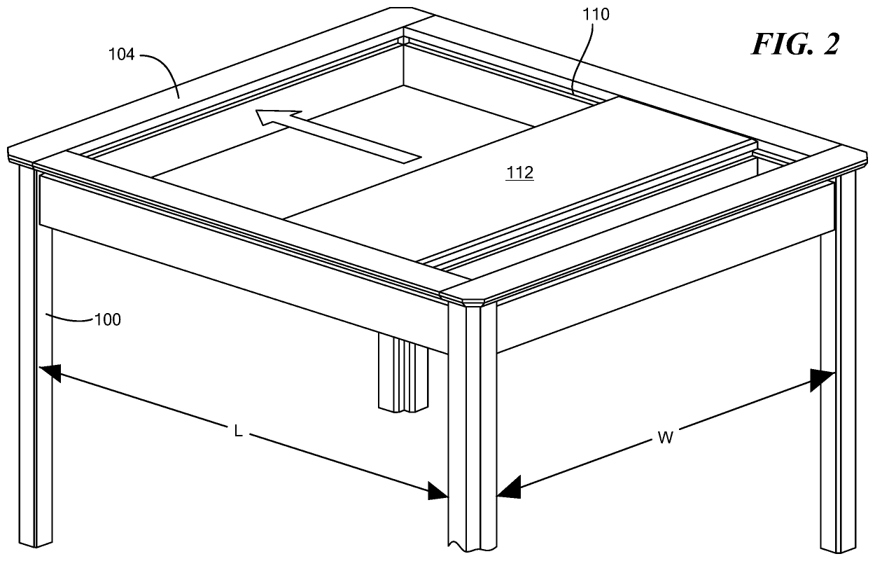

Referring to FIG. 2, table 100 is shown with the deck accessory placed on the rails 110. As mentioned above, in this arrangement deck accessory 112 can move back and forth along length L of the table 100. In embodiments, the top surface of deck accessory 112 may be flush with the top surface 104 of table 100. In other embodiments, the top surface of deck accessory 112 may be raised or recessed with respect to top surface 104 of table 100.

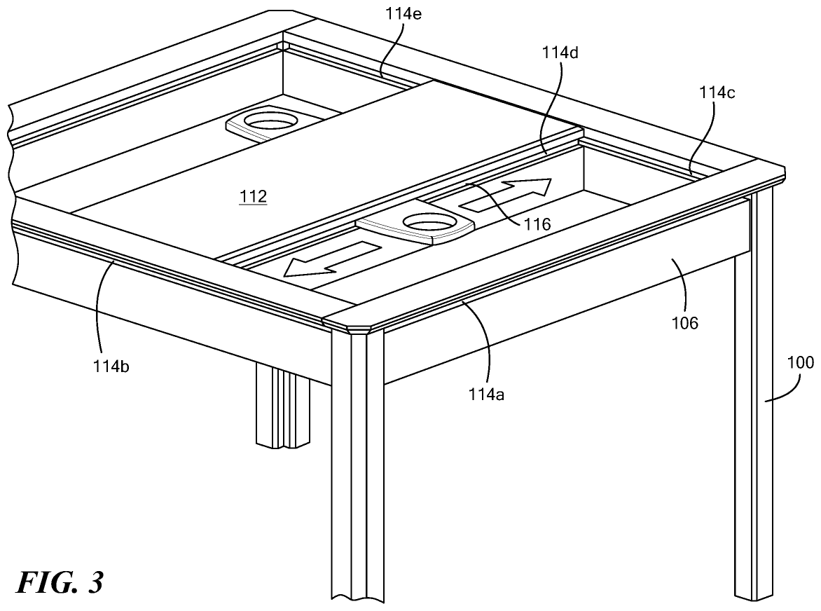

Referring to FIG. 3, table 100 is again shown with the deck accessory 112 in place. Magnetic elements 114a-e may be located in various locations of the table 100 and deck 112. For example, magnetic elements 114a and 114b are located on outside surfaces (e.g an outer wall) of the table. Magnetic element 114c is located on an inside surface (e.g. an inner wall) of the table. And magnetic elements 114d and 114e are located on the sides of the deck accessory 112. Any or all of these magnetic elements 114 may be used in conjunction with a furniture accessory to hold the accessory in place.

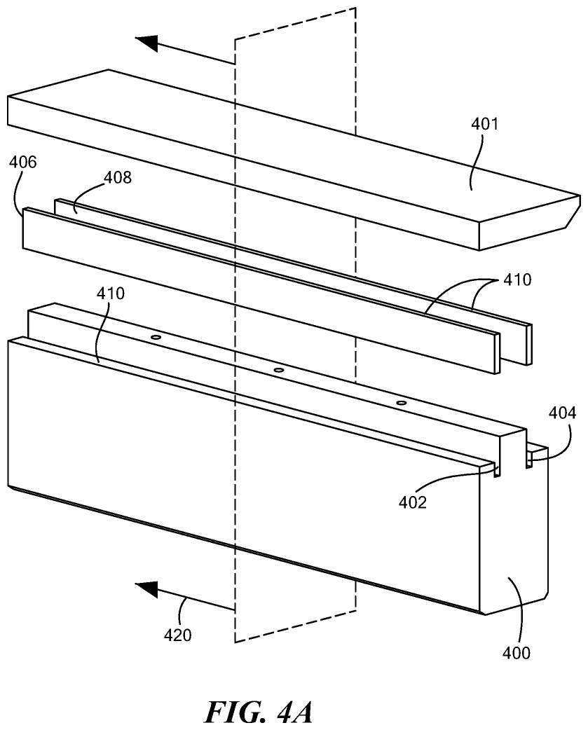

Referring to FIG. 4A, a table apron 400 and top piece 401 are shown in an exploded view. Apron 400 may be the same as or similar to apron 106 (or any of the other aprons) in FIG. 1 and top piece 401 may be the same as or similar to top piece 104 (or any of the other top pieces) in FIG. 1. The Apron 400 includes one or more slots 402, 404 to accept magnetically attractive elements 406 and 408, respectively. In embodiments, the width of the slots 402, 404 may be the same as or slightly larger than the width of the magnetically attractive elements 406, 408 to create a flush fit when the magnetic elements 406, 408 are placed into the slots 402, 404. In some embodiments, the magnetically attractive elements 406, 408 may be held in place within slots 402 and 404 by an adhesive (e.g. glue) or fasteners (e.g. screws). Also, the top piece 401 may have slots on its bottom side (not shown) that can engage with the top edges 410 of magnetic elements 406, 408 to hold magnetic elements 406, 408 in place.

FIG. 4B is a cross sectional view of apron 400 and top piece 401 in an assembled state as seen from the direction of arrow 420. When top piece 401 is joined to apron 400, the top surface of top edge 410 and the bottom surface 414 of top piece 401 form an opening (e.g. a groove) 416 with magnetically attractive element 406 at the back of the groove. Similarly, the top surface of lip 412 and the bottom surface 414 of top piece 401 form a groove 418 with magnetically attractive element 408 located at the back (i.e. the inner portion) of groove 418. In embodiments, caps 422 may be fitted into the grooves to protect the magnetically attractive elements 406, 408 and conceal them from view. The grooves 416 and 418 may be configured to accept a furniture accessory, as will be discussed below.

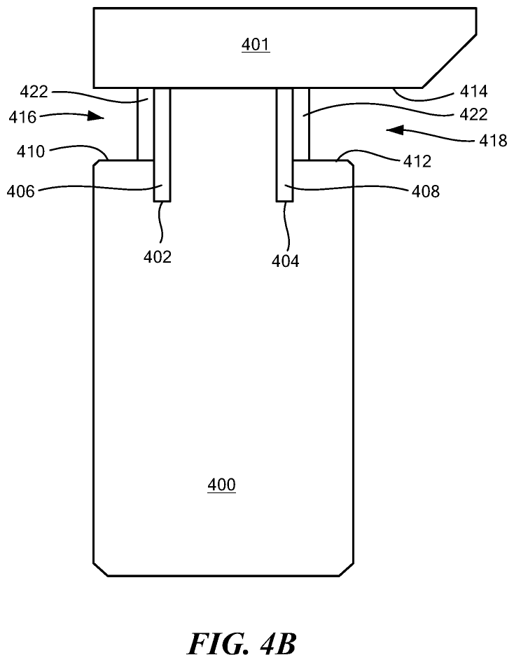

FIG. 5 is a side view of a deck 500, which may be the same as or similar to deck 112 shown in FIG. 1. One or more sides of deck accessory 112 may include grooves 501 and 502 into which one or more furniture accessories 504 may be inserted. Magnetically attractive elements 506 and 508 may be positioned inside the grooves, as shown. Magnets within furniture accessory 504 may interact with magnetically attractive element 508 to hold furniture accessory in place within groove 502, as shown. In other embodiments, magnetically attractive elements 506 and/or 508 may be positioned adjacent to or near the grooves 501 and 502. They may be positioned in any location as long as they can interact with and hold in place magnetic furniture accessories that are placed within the grooves 501 and 502.

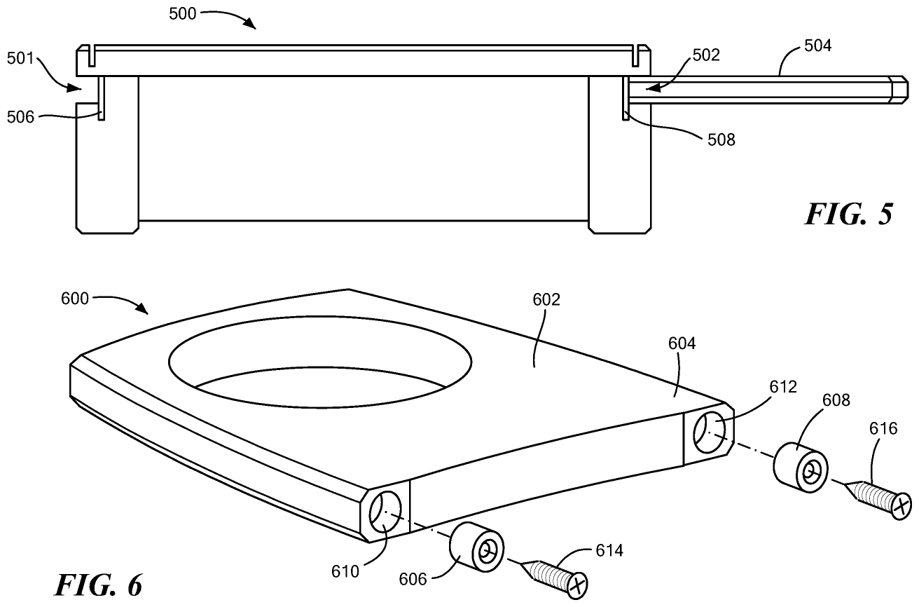

Referring to FIG. 6, a magnetic furniture accessory 600 is shown in an exploded view. The magnetic accessory 600 includes a body 602 with a tongue portion 604. The tongue portion 604 is configured to fit into a groove of a magnetic rail (e.g. groove 416 and/or 418 of FIG. 4B). The tongue portion 604 may include one or more magnets 606 and 608 that are inserted and fastened into holes 610 and 612 by screws 614 and 616, respectively. When placed within groove 416, the magnets attract to magnetically attractive element 406 within the groove (e.g. magnetic element 116) to fasten the magnetic accessory 600 into place. In the embodiment shown, the magnetic accessory 600 is a cup holder. However, other magnetic accessories may include dice holders, dice trays, eating trays, desks, card holders, portable power supply holders, electronic displays, phone or tablet holders, and the like.

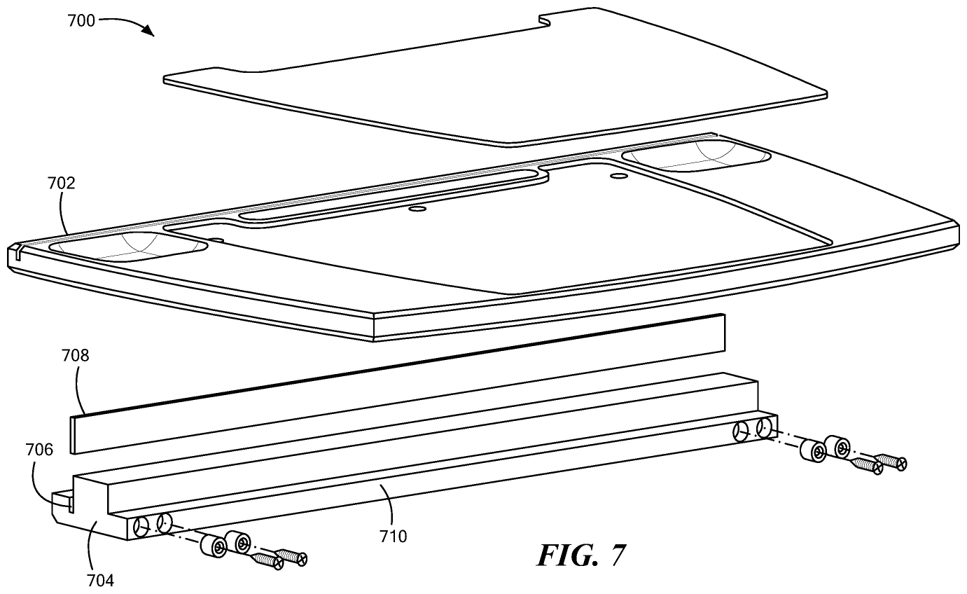

Referring to FIG. 7, an exploded view of a desk accessory 700 for a table 100 is shown. The desk accessory 700 includes a top portion 702 and a bottom portion 704. The bottom portion includes a groove 706 into which a magnetically attractive element 708 is placed. The bottom portion also includes a tongue 710 that includes one or more magnets 712. The tongue is configured to fit into a groove in a table apron. For example, tongue 710 may be placed into groove 416 (shown in FIG. 4B) to attach and secure the desk accessory 700 to the table. When tongue 710 is inserted into groove 416, the magnets 712 attract to the magnetically attractive element 406 which creates a retaining force that holds the desk accessory in place. The retaining force has a strength that is chosen to allow a user to reposition or remove the accessory with relative ease. In addition, the bottom portion 704 and the top portion 702 form a magnetic groove (like groove 416 in FIG. 4B) that other magnetic accessories can be placed into.

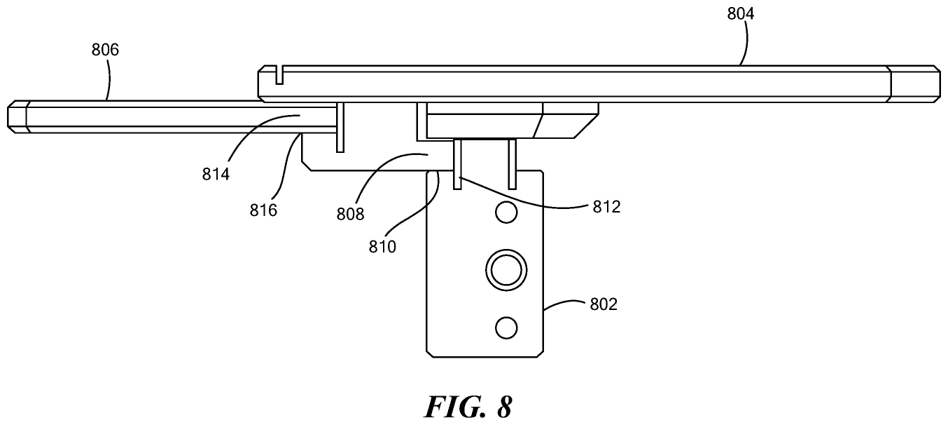

FIG. 8 is a side view of a table apron 802 (which may be the same as or similar to table apron 106 in FIG. 1) and a magnetic desk accessory 804 (which may be the same as or similar to desk accessory 700 in FIG. 7). The magnetic desk accessory 804 includes a tongue 808 that can be inserted into the groove 810 of table apron 802. Magnets within the tongue 808 may magnetically attract to magnetically attractive element 812 within groove 810 to hold the desk accessory 804 in place.

A magnetic furniture accessory 806 is also shown. Accessory 806 includes a tongue portion 814 that is inserted into groove 816 of desk accessory 804. Magnets (not shown) within tongue portion 814 may magnetically attract to magnetically attractive element 818 within groove 816 to hold accessory 806 in place.

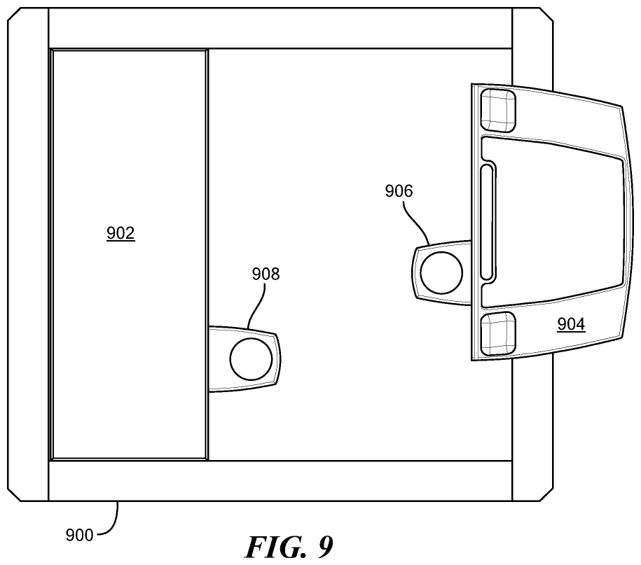

FIG. 9 is a top view of a table 900 (which may be the same as or similar to table 100 of FIG. 1) with a deck accessory 902 (which may be the same as or similar to deck accessory 112). A desk accessory 904 (which may be the same as or similar to desk accessory 700) is positioned within a groove on an inner wall of the table. A furniture accessory 906 is positioned in the groove of the desk accessory 904 and a magnetic accessory 908 is positioned in the groove of the deck accessory 902. Magnets within the desk accessory 904 and accessories 906 and 908 secure the accessories in place within the grooves and allow the accessories to slide back and forth to be repositioned within the grooves.

Various embodiments of the concepts, systems, devices, structures, and techniques sought to be protected are described above with reference to the related drawings. Alternative embodiments can be devised without departing from the scope of the concepts, systems, devices, structures, and techniques described. It is noted that various connections and positional relationships (e.g., over, below, adjacent, etc.) may be used to describe elements in the description and drawing. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising, “include,” “includes,” “including,” “has,” “having,” “contains” or “containing,” or any other variation are intended to cover a non-exclusive inclusion. For example, an apparatus, a method, a composition, a mixture or an article, that comprises a list of elements is not necessarily limited to only those elements but can include other elements not expressly listed or inherent to such apparatus, method, composition, mixture, or article.

Additionally, the term “exemplary” is means “serving as an example, instance, or illustration. Any embodiment or design described as “exemplary” is not necessarily to be construed as preferred or advantageous over other embodiments or designs. The terms “one or more” and “at least one” indicate any integer number greater than or equal to one, i.e. one, two, three, four, etc. The term “plurality” indicates any integer number greater than one. The term “connection” can include an indirect “connection” and a direct “connection”.

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it may affect such feature, structure, or characteristic in other embodiments whether or not explicitly described.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

1. A piece of furniture comprising:
a groove along at least one side of the piece of furniture; and
a magnetically attractive rail positioned within the groove;
wherein the groove is configured to accept a furniture accessory having a tongue and having magnetic elements disposed about the tongue, the magnetic elements configured to interact with the rail to hold the accessory in place when the tongue is inserted into the groove.

2. The piece of furniture of claim 1 wherein the rail is positioned along an outer wall of the piece of furniture.

3. The piece of furniture of claim 1 wherein the rail is positioned along an inner wall of the piece of furniture.

4. The piece of furniture of claim 1 wherein the rail comprises a metal strip that extends horizontally along the side of the piece of furniture.

5. The piece of furniture of claim 4 wherein the metal strip comprises one or more of: a metal bar, a metal rod, a metal foil.

6. The piece of furniture of claim 1 wherein the rail comprises a magnet.

7. The piece of furniture of claim 1 wherein the rail is positioned within a slot located at an inner portion of the groove.

8. The piece of furniture of claim 1 wherein the rail is covered by a covering.

9. A furniture accessory comprising:
a tongue configured to be inserted into a groove of a piece of furniture; and
magnetic element disposed about the tongue, the magnetic elements configured to interact with a magnetically attractive element of a piece of furniture to hold the furniture accessory in place when the tongue is inserted into a first groove of the piece of furniture.

10. The furniture accessory of claim 9 further comprising:
a second groove along at least one side of the furniture accessory; and
a magnetically attractive rail positioned within the second groove;
wherein the second groove is configured to accept a second furniture accessory having a second tongue and having second magnetic elements disposed about the second tongue, the second magnetic elements of the second furniture accessory configured to interact with the rail to hold the second furniture accessory in place when the tongue of the second furniture accessory is inserted into the second groove.

11. A furniture system comprising:
a piece of furniture having a magnetically attractive rail along at least one side of the piece of furniture, the rail positioned within a groove on the side of the piece of furniture;
a furniture accessory configured to attach to the piece of furniture, the furniture accessory having:
a tongue; and
magnetic elements disposed about the tongue, the magnetic elements configured to interact with the rail to hold the furniture accessory in place when the tongue is inserted into the groove.

12. The furniture system of claim 11 wherein the rail is positioned along an outer wall of the piece of furniture.

13. The furniture system of claim 11 wherein the rail is positioned along an inner wall of the piece of furniture.

14. The furniture system of claim 11 wherein the rail comprises a metal strip that extends horizontally along the side of the piece of furniture.

15. The furniture system of claim 14 wherein the metal strip comprises one or more of: a metal bar, a metal rod, a metal foil.

16. The furniture system of claim 11 wherein the rail comprises a magnet.

17. The furniture system of claim 11 wherein the rail is positioned within a slot located at an inner portion of the groove.

18. The furniture system of claim 11 wherein the rail is covered by a covering.

19. The furniture system of claim 11 wherein:
the furniture accessory comprises:
a second groove along at least one side of the furniture accessory; and
a magnetically attractive rail positioned within the second groove;
wherein the second groove is configured to accept a second furniture accessory having a second tongue and having second magnetic elements disposed about the second tongue, the second magnetic elements of the second furniture accessory configured to interact with the rail to hold the second furniture accessory in place when the tongue of the second furniture accessory is inserted into the second groove.
